(19) United States
(12) Patent Application Publication
(10) Pub. No.: US 2016/0062877 A1
(43) Pub. Date: Mar. 3, 2016

(54) GENERATING COVERAGE METRICS FOR BLACK-BOX TESTING

(71) Applicant: International Business Machines Corporation, Armonk, NY (US)

(72) Inventors: Omer Tripp, Bronx, NY (US); Emmanuel Wurth, Muret (FR)

(21) Appl. No.: 14/731,549

(22) Filed: Jun. 5, 2015

(30) Foreign Application Priority Data
Sep. 3, 2014 (GB) 1415578.2

(51) Int. Cl. G06F 11/36

(52) U.S. Cl. CPC G06F 11/3684; G06F 11/3688; G06F 11/3692

(57) ABSTRACT

Generating coverage metrics for black-box testing includes performing static analysis of a program code to be tested. The static analysis includes identifying variables whose value depends on inputs of the program code. Code blocks are inserted into the program code to be tested. The code blocks insert vulnerabilities into the code at locations where the variables are modified. The code blocks violate one or more properties to be tested. A testing scan is applied to the program code and vulnerabilities are located by the test. A coverage metric is output based on the ratio of the located vulnerabilities to the total number of inserted vulnerabilities in the program code.

### BACKGROUND

This invention relates to the field of generating coverage metrics for black-box testing. In particular, the invention relates testing of software systems with application in security testing of web applications and services.

Black-box testing has shown great success over the last decades in pinpointing rare and subtle software defects. Notable examples come from the domains of security and concurrency.

### SUMMARY

According to a first aspect of the present invention there is provided a method for generating coverage metrics for black-box testing, which includes performing static analysis of a program code to be tested, whereby the static analysis includes identifying variables whose value depends on inputs of the program code. The method may also include inserting code blocks into the program code to be tested, whereby the code blocks insert vulnerabilities into the code at locations where the variables are modified and wherein the code blocks violate one or more properties to be tested. The method may further include applying a testing scan to the program code and determining a number of vulnerabilities located by the test. The method may also include outputting a coverage metric based on the ratio of the located vulnerabilities to the total number of inserted vulnerabilities in the program code. The method may further include performing static analysis of the program code may use data flow analysis techniques. Preferably, inserting code blocks does not disrupt the behavior of the program code including encapsulating the code blocks and the code blocks manipulating fresh variables and memory. Additionally, the method may include selecting a property and generating code blocks that exhibit violations of the property. The method may further determine if the output coverage metric is above an acceptable threshold. The method may modify the testing scan based on feedback from the coverage metric and may iterate the testing scan until an acceptable threshold of coverage metric is achieved.

According to a second aspect of the present invention there is provided a system for generating coverage metrics for black-box testing, may include a coverage analysis tool including a static analysis component for performing static analysis of a program code to be tested, whereby the static analysis includes identifying variables whose value depends on inputs of the program code. Also included is a vulnerability adding component for inserting code blocks into the program code to be tested, whereby the code blocks insert vulnerabilities into the code at locations where the variables are modified and wherein the code blocks violate one or more properties to be tested. Additionally, a test analysis component is included for applying a testing scan to the program code and determining a number of vulnerabilities located by the test. Furthermore, a reporting component is included for outputting a coverage metric based on the ratio of the located vulnerabilities to the total number of inserted vulnerabilities in the program code. The system may include or be associated with a testing tool for carrying out the testing scan and providing the results to the coverage analysis tool. Preferably, the vulnerability adding component for inserting code blocks does not disrupt the behavior of the program code including encapsulating the code blocks and the code blocks manipulating fresh variables and memory. Additionally, the system may include a coverage evaluation component for determining if the output coverage metric is above an acceptable threshold. A testing tool modifier component may be provided for modifying the testing scan based on feedback from the coverage metric and iterating the testing scan until an acceptable threshold of coverage metric is achieved.

According to a third aspect of the present invention there is provided a computer program stored on a computer readable medium and loadable into the internal memory of a digital computer, comprising software code portions, when said program is run on a computer, for performing the method steps of the first aspect of the present invention.

The described aspects of the invention provide the advantage of providing an indication of a coverage of a black-box testing tool.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a schematic diagram of a method in accordance with the present invention;

FIG. 2 is a flow diagram of an example embodiment a method in accordance with the present invention;

FIG. 3 is a flow diagram of an example embodiment a method in accordance with the present invention;

FIG. 4 is block diagram of an example embodiment of a system in accordance with the present invention; and

FIG. 5 is a block diagram of an embodiment of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A powerful property of black-box testing lies in the idea of simulating an external user of the system. This gives the testing system high confidence that once a potential defect has been detected, then it is almost certainly a true defect that the developer should address.

Naturally, however, black-box testing tools are not complete. There are bugs, or defects, that such tools may miss as a result of interacting with the given software module “from the outside” and without intimate knowledge of its internal modules and their behavior.

Still, a developer applying a black-box testing tool to his or her system would like to get a sense of how deep or thorough the scan was. For example, assuming a security assessment tool like IBM Security AppScan Standard Edition (IBM and AppScan are trademarks of International Business Machines Corporation), if the tool is applied to a web application or a web service and reports very few findings or no findings at all, then it is not clear to the developer of that software system how confident he or she should be given this analysis result.

Raw and low-level metrics for measuring coverage may provide little insight to the developer and are often not even correlated with the business logic of the software system at hand. Examples include the following: reporting which web pages or web methods the tool exercised (in general, and with respect to an online model of the application or service); reporting of coverage in terms of lines of code (which requires full instrumentation of the program); reporting of coverage in terms of input points (e.g. HTTP parameters).

Clearly, none of these metrics answers the important question of how complete the analysis was. Moreover, some of these metrics incur high overhead during testing of the subject application or service.

To complicate matters even more, often the testing tool has a wide range of configurable behaviors. This means that the developer can control the degree to which the tool is complete, for example, by tuning different thresholds that govern the number of payload variants the tool tries, the depth to which it explores the subject application or service to approximate its attack surface and business logic, etc.

Configuring the tool without a meaningful form of guidance, including telling the developer to what level the current configuration proved effective in terms of tool coverage, is a tiresome, burdensome, error prone, and in fact, hopeless task. The user has to guess whether to try additional configurations rather than receiving clear indications by the tool itself. A method and system are provided for evaluating coverage of black-box testing, which includes statically analyzing a tested program to identify variables and expressions whose values depend on the inputs of the program.

The method then injects in the program, at the location where those variables are modified, a vulnerability statement, creating a marked vulnerability on the underlying database. The black box campaign may be performed outputting an efficacy metric of coverage of this black box test campaign defined as the ratio of found errors over the total number of injections performed.

A property P to be tested by the analysis may be selected. Variables and expressions detected by the static analysis are used to create code blocks that exhibit violations of P (of different kinds and categories) and these vulnerabilities are injected into the code of the subject web application or web service.

During and/or after the testing cycle in which inputs are provided to the program, it can then be checked how many of the injected vulnerabilities were detected by the analysis tool. This provides a semantic means of measuring the completeness of the testing cycle with respect to the given application.

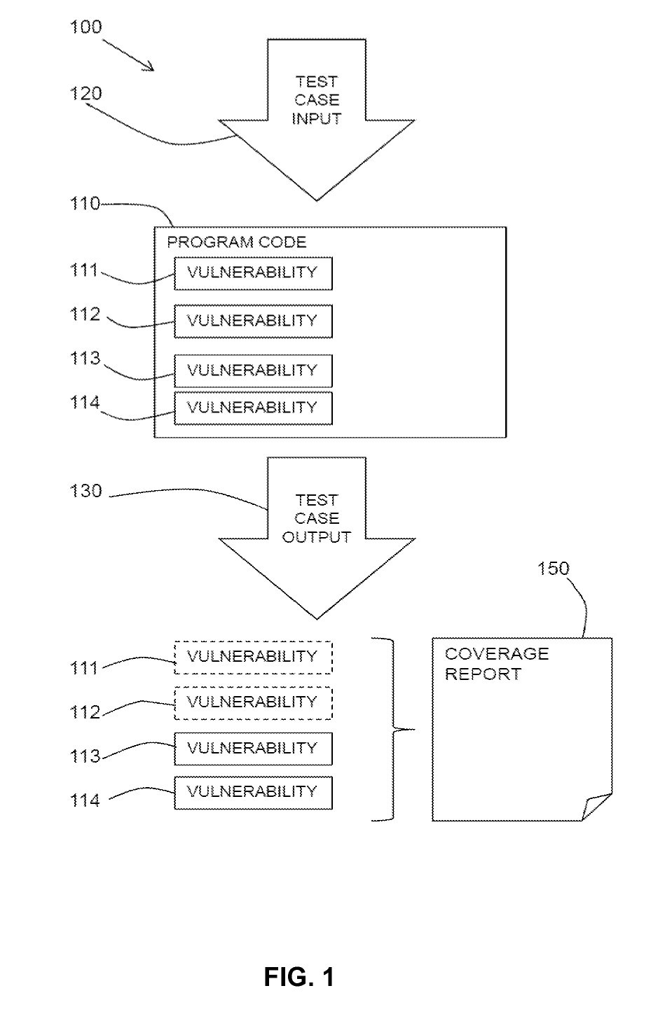

Referring to FIG. 1, a schematic diagram 100 illustrates a method, according to one or more embodiments of the present invention. Program code 110 which may be for an application or service has vulnerabilities 111-114 injected into it. The vulnerabilities 111-114 exhibit violations of a property.

A test case input 120 is input to the program code 110 and a test case output 130 is output. The test case output 130 may have identified some 113, 114 or all of the vulnerabilities and a coverage report 150 may be generated based on these results.

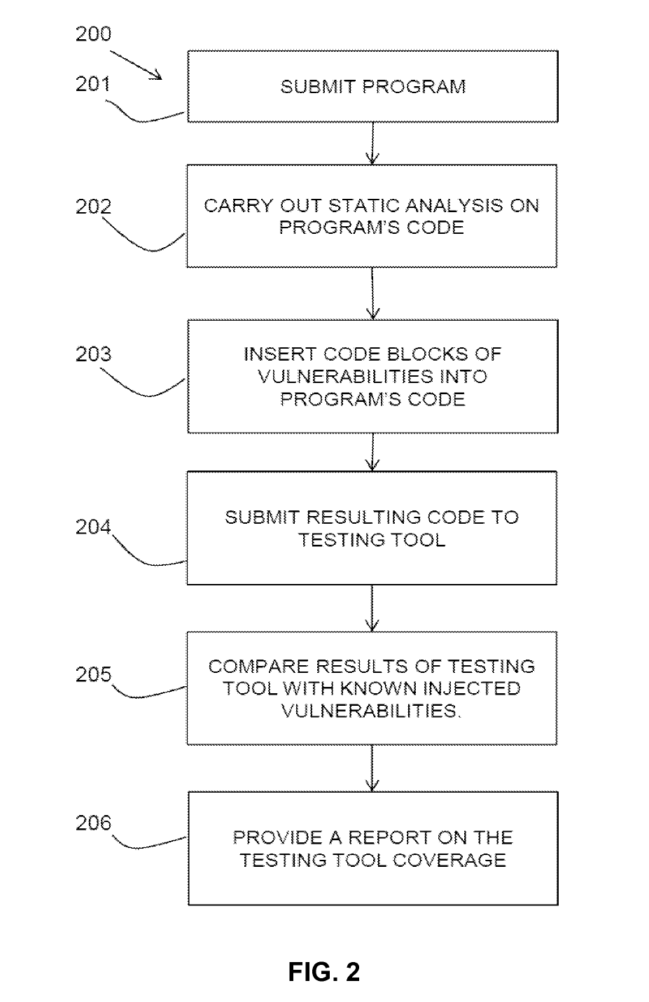

Referring to FIG. 2, a flow diagram 200 shows an embodiment of the described method.

The developer submits 201 the subject program to a coverage analysis tool. The program may be a web application or web service.

A static analysis is carried out 202 of the program's code to detect input points and flow of information. In particular, the static analysis may identify variables or expressions whose value depends on the inputs of the program. This may be done using standard data-flow analysis techniques.

The static analysis does not need to be carried out on the source code. This may be, if a testing team does not have access to the source code. For example, byte code may be used and updated for a Java program without the need for the Java source files. Code blocks giving rise to different forms of vulnerabilities are then inserted 203 into the code to exhibit properties using the detected inputs. Code blocks may be inserted for vulnerabilities of multiple different properties.

The code blocks may be inserted in such a way that it does not disrupt its original behavior and semantics. That is, the code blocks may be encapsulated and manipulate fresh variables and memory. The code blocks may be located at the locations where the variables and expressions are modified.

The resulting code is then submitted 204 to the testing tool. During and/or after the scan by the testing tool, the coverage analysis tool compares 205 the report by the testing tool with the expected findings according to the vulnerable code blocks that were weaved into the original code, and provides 206 a semantic report of the testing tool's coverage.

A method of evaluating the efficacy of a black-box testing campaign may include performing an initial black box campaign of which the coverage is uncertain, then analyzing statically the tested program to identify the variables and expressions whose value depends on the inputs of the program. Vulnerability statements may be injected in the program, at the location where those variables are modified, creating a marked vulnerability on the underlying database. The black box campaign may be performed again using the same data and outputting an efficacy metric of coverage of this black box test campaign defined as the ratio of found errors over the total number of injections performed.

The description above can of course be generalized to other properties by inserting “issues” in order to check if they are detected by a testing tool. The properties are not limited to SQL injection or security vulnerabilities but may also include other scenarios such as detection of concurrency violations (such as race conditions and deadlocks), by parameterizing the entire sequence of steps on the property being tested. If the tested property is, for instance, deadlocks, then the synthesized code blocks contain deadlocks. The described method is applicable for users other than the developer, in which case the source code of the subject web application or web service may not be available. This is because there are existing code instrumentation and editing tools and techniques that apply at the byte code/binary level.

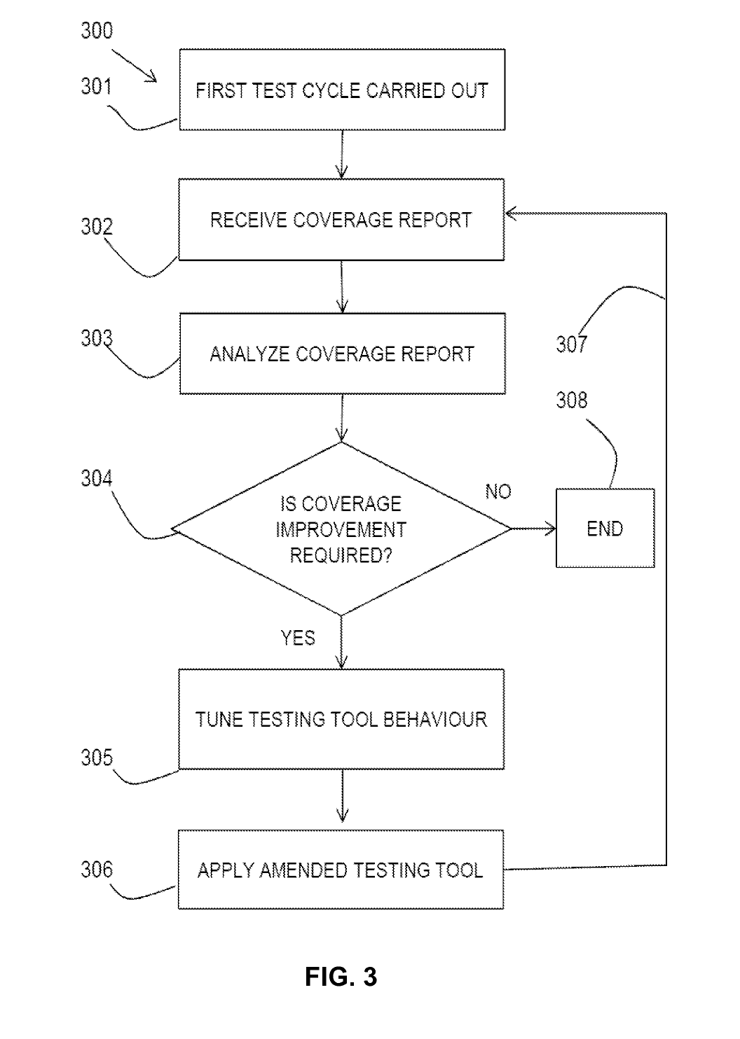

Referring to FIG. 3, a flow diagram 300 illustrates a further aspect of the described method. This aspect provides steps beyond the flow of FIG. 2 and provides auto-configuration of the coverage analysis tool.

A first test cycle may be carried out 301 as described with reference to FIG. 2. The resultant coverage report may be received 302 and analyzed 303. It is determined 304 if coverage improvement of the testing tool is required. If it is required, the testing tool behavior is tuned to improve on the coverage. According to the coverage report, different settings and parameters that govern the behavior of the testing tool may be tuned so as to increase coverage.

The amended testing tool may then be applied 306 and the method may iterate 307. This can become an iterative process, whereby the coverage analysis tool changes the testing tool's configuration, then tests for coverage, then updates the configuration again, etc.

If it is determined 304 that the no coverage improvement is required, the method may end 308.

The selection of options and settings in a testing tool by an end user may have a strong influence on the testing coverage and therefore the results might be very different. This might lead to some vulnerabilities not being discovered by the black block testing tool with some end user configurations. The described method of providing coverage metrics is useful as the end user can realize that the testing tool is not working well since only a few vulnerability are discovered, in which case the end user can change the configuration of the testing tool and use more in depth settings. An example of such configuration would be the tuning of the processes and technology used to check URLs by the testing tool. In such a case, multiphase scanning should be engaged to provide a better analysis, and/or Java script vulnerability analysis should be engaged, etc.

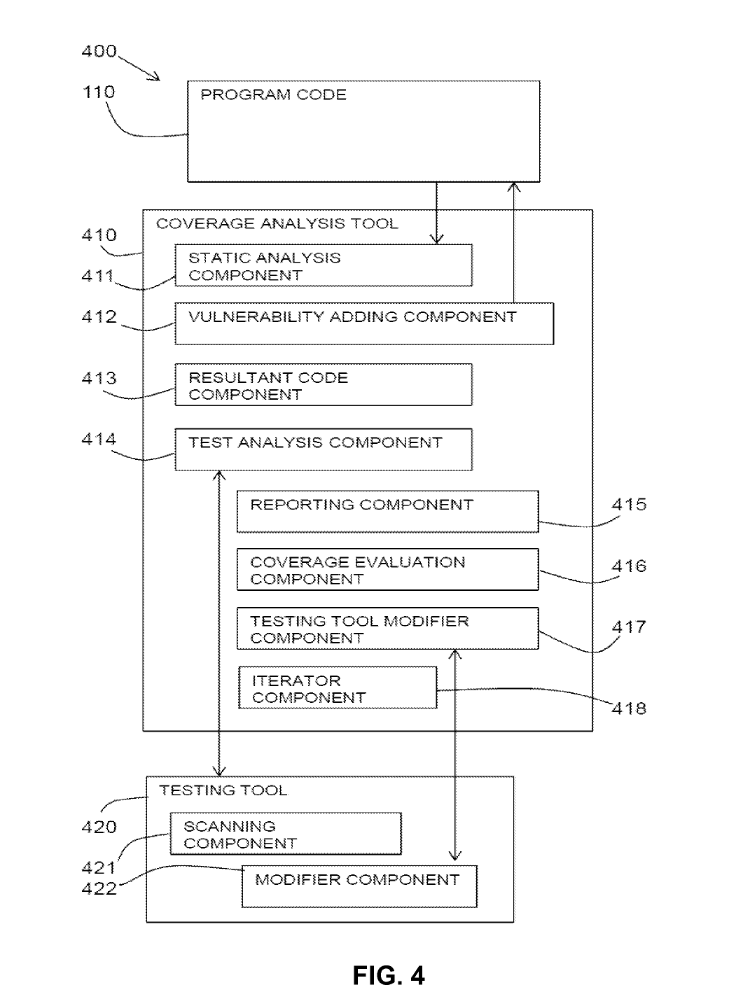

Referring to FIG. 4, a block diagram shows an embodiment of the system 400. The system 400 includes a program code 110 to be tested and a testing tool 420. The system 400 also includes a coverage analysis tool 410 for reporting on the coverage of a testing tool for a given program code 110.

The coverage analysis tool 410 may include a static analysis component 411 for carrying out static analysis of the program code 110 to identifying variables and expressions whose value depends on the inputs of the program. A vulnerability adding component 412 may insert code blocks into the program code 110 at locations where variables and expressions are modified.

A resultant code component 413 submits the resultant program code 110 including the inserted vulnerabilities to the testing tool 420 where a scanning component 421 scans the program code 110. A test analysis component 414 of the coverage analysis tool 410 may analyze the testing tool results during and/or after the testing against the known vulnerabilities. A reporting component 415 may provide a report on the testing coverage.

A coverage evaluation component 416 of the coverage analysis tool 410 may determine if the coverage is acceptable. This may include input from a user or measuring against defined thresholds of coverage.

The coverage analysis tool 410 may include a testing tool modifier component 417 for modifying the testing tool to improve the testing coverage in response to the coverage results. A corresponding modifier component 422 at the testing tool 420 may affect the modifications. An iterator component 418 may control further iteration of modifications to the testing tool 420 until the coverage evaluation component 416 determines that the coverage is acceptable.

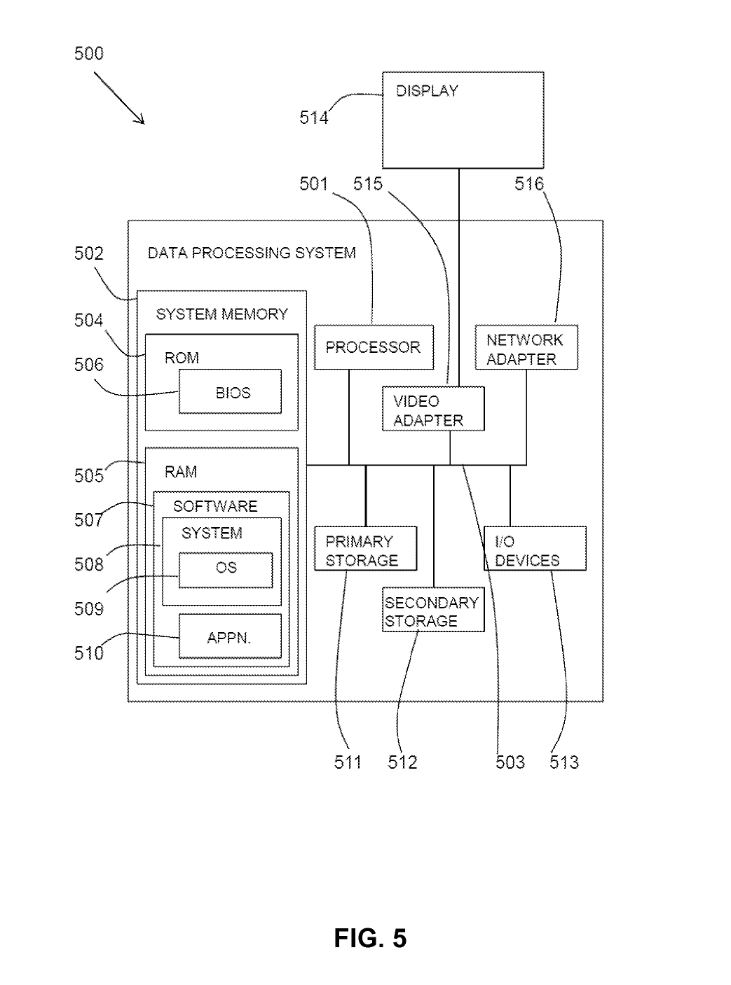

Referring to FIG. 5, an exemplary system for implementing aspects of the invention includes a data processing system 500 suitable for storing and/or executing program code including at least one processor 501 coupled directly or indirectly to memory elements through a bus system 503. The memory elements may include local memory employed during actual execution of the program code, bulk storage, and cache memories which provide temporary storage of at least some program code in order to reduce the number of times code must be retrieved from bulk storage during execution.

The memory elements may include system memory 502 in the form of read only memory (ROM) 504 and random access memory (RAM) 505. A basic input/output system (BIOS) 506 may be stored in ROM 504. System software 507 may be stored in RAM 505 including operating system software 508. Software applications 510 may also be stored in RAM 505.

The system 500 may also include a primary storage means 511 such as a magnetic hard disk drive and secondary storage means 512 such as a magnetic disc drive and an optical disc drive. The drives and their associated computer-readable media provide non-volatile storage of computer-executable instructions, data structures, program modules and other data for the system 500. Software applications may be stored on the primary and secondary storage means 511, 512 as well as the system memory 502.

The computing system 500 may operate in a networked environment using logical connections to one or more remote computers via a network adapter 516.

Input/output devices 513 may be coupled to the system either directly or through intervening I/O controllers. A user may enter commands and information into the system 500 through input devices such as a keyboard, pointing device, or other input devices (for example, microphone, joy stick, game pad, satellite dish, scanner, or the like). Output devices may include speakers, printers, etc. A display device 514 is also connected to system bus 503 via an interface, such as video adapter 515.

An example of a security analysis, SQL Injection is described.
Step 1: The initial code of the program is as follows.
   public void doGet(HttpServletRequest req) {
   String username=req.getParameter(“name”);
   . . .
   SQLDBConnection connection=. . . ;
   . . .
   }
Step 2: Run a static analysis for the SQL injection context, which detects the doGet( . . . ) entrypoint and the getParameter( . . . ) source.
Step 3: Interleave SQ injection instances into the code above, as follows:
   public void doGet(HttpServletRequest req) {
   String username=req.getParameter(“name”);
   . . .
   SQLDBConnection connection=. . . ;
   . . .

### {// INJECTED VULNERABILITY #1

db.insert( . . . +username+ . . . ); // simple SQLi
}

### {// INJECTED VULNERABILITY #2

if (req.getParameter(“address”) !=null) db.insert( . . . +username+ . . . ); // more advanced case
} etc . . .
Step 4: Black box testing tool is re-executed.
Step 5: It can now be checked which of the injected vulnerabilities, if any, the analysis detected. This would give an indication of how well the analysis covered the original code under the doGet( . . . ) entrypoint.

It is assumed that the analysis searches for injection vulnerabilities (like cross-site scripting and SQL injection). The ability by the tool to detect such vulnerabilities is dependent on multiple factors, including the following:
the variants it attempts during testing of a given input point;
the types of input points it exercises;
the validation techniques it uses;
the bounds the tool has on number of input points;
etc.

It would be extremely difficult, if not impossible, for the developer, to manually evaluate the overall effect of all these parameters on the coverage provided by the tool. The described method and system provide an output of a coverage metric for black-box testing tools which enables improved feedback and focus of configuration of a testing tool. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Improvements and modifications can be made to the foregoing without departing from the scope of the present invention.

What is claimed is:

1. A method for generating coverage metrics for black-box testing, comprising:
performing static analysis of a program code to be tested, wherein the static analysis includes identifying variables whose value depends on inputs of the program code;
inserting code blocks into the program code to be tested, wherein the code blocks insert vulnerabilities into the code at locations where the variables are modified and wherein the code blocks violate one or more properties to be tested;
applying a testing scan to the program code and determining a number of vulnerabilities located by the test; and
outputting a coverage metric based on the ratio of the located vulnerabilities to the total number of inserted vulnerabilities in the program code.

2. The method of claim 1, wherein performing static analysis of the program code uses data flow analysis techniques.

3. The method of claim 1, wherein inserting code blocks does not disrupt the behavior of the program code including encapsulating the code blocks and the code blocks manipulating fresh variables and memory.

4. The method of claim 1, further comprising:
selecting a property and generating code blocks that exhibit violations of the property.

5. The method of claim 1, further comprising:
determining if the output coverage metric is above an acceptable threshold.

6. The method of claim 1, further comprising:
modifying the testing scan based on feedback from the coverage metric and iterating the testing scan until an acceptable threshold of coverage metric is achieved.

7. A system for generating coverage metrics for black-box testing, comprising:
a coverage analysis tool including:
a static analysis component for performing static analysis of a program code to be tested, wherein the static analysis includes identifying variables whose value depends on inputs of the program code;
a vulnerability adding component for inserting code blocks into the program code to be tested, wherein the code blocks insert vulnerabilities into the code at locations where the variables are modified and wherein the code blocks violate one or more properties to be tested;
a test analysis component for applying a testing scan to the program code and determining a number of vulnerabilities located by the test; and
a reporting component for outputting a coverage metric based on the ratio of the located vulnerabilities to the total number of inserted vulnerabilities in the program code.

8. The system of claim 7, including a testing tool for carrying out the testing scan and providing the results to the coverage analysis tool.

9. The system of claim 7, wherein the vulnerability adding component for inserting code blocks does not disrupt the behavior of the program code including encapsulating the code blocks and the code blocks manipulating fresh variables and memory.

10. The system claim 7, further comprising:
including a coverage evaluation component for determining if the output coverage metric is above an acceptable threshold.

11. The system of claim 7, further comprising:
a testing tool modifier component for modifying the testing scan based on feedback from the coverage metric and iterating the testing scan until an acceptable threshold of coverage metric is achieved.

12. A computer program product for generating coverage metrics for black-box testing, the computer program product comprising:
one or more computer-readable storage devices and program instructions stored on at least one of the one or more tangible storage devices, the program instructions executable by a processor, the program instructions comprising:
program instructions to perform static analysis of a program code to be tested, wherein the static analysis includes identifying variables whose value depends on inputs of the program code;
program instructions to insert code blocks into the program code to be tested, wherein the code;
program instructions to block insert vulnerabilities into the code at locations where the variables are modified and wherein the code blocks violate one or more properties to be tested;
program instructions to apply a testing scan to the program code and determining a number of vulnerabilities located by the test; and
program instructions to output a coverage metric based on the ratio of the located vulnerabilities to the total number of inserted vulnerabilities in the program code.

13. The computer program product of claim 12, wherein performing static analysis of the program code uses data flow analysis techniques.

14. The computer program product of claim 12, wherein inserting code blocks does not disrupt the behavior of the program code including encapsulating the code blocks and the code blocks manipulating fresh variables and memory.

15. The computer program product of claim 12, further comprising:
program instructions to select a property and generating code blocks that exhibit violations of the property.

16. The computer program product of claim 12, further comprising:
program instructions to determine if the output coverage metric is above an acceptable threshold.

17. The computer program product of claim 12, further comprising:
program instructions to modify the testing scan based on feedback from the coverage metric and iterating the testing scan until an acceptable threshold of coverage metric is achieved.
